(19) United States
(12) Patent Application Publication
(10) Pub. No.: US 2011/0119971 A1
(43) Pub. Date: May 26, 2011

(54) WATER BALL WITH DANCING BEAD

(76) Inventor: Tsan-Yao CHEN, Taipei (TW)

(21) Appl. No.: 12/626,328

(22) Filed: Nov. 25, 2009

(51) Int. Cl. G09F 19/02

(52) U.S. Cl. 40/406

(57) ABSTRACT

A water ball with dancing beads is revealed. The water ball includes a transparent container that is sealed by a bottom cover to form a closed container, a first space with an impeller disposed on a bottom of the closed container, at least one vent arranged at a top surface of the first space, a second space with a hole on a center of the bottom surface thereof, and a driving member that drives the impeller to rotate. Thereby when the impeller rotates, a centrifugal force generated forces a plurality of beads in the first space passing through the vent and moving upward while beads falling freely slide into the second space through a gap on an inner circumference of the transparent container, pass the hole and turn back to the first space.

### BACKGROUND OF THE INVENTION

The present invention relates to a water ball with dancing beads, especially to a water wall in which a plurality of beads in a transparent closed water wall is blown up from a bottom side thereof to a top side and is shaken by centrifugal force from a rotated impeller.

Water balls are traditional ornaments and gifts. The water wall mainly includes a transparent container and a base. The transparent container is filled with liquid such as a single liquid (water) or double liquid (water and oil) and is disposed with various ornaments and/or related driving members so as to achieve static or dynamic decorative effects. The inventor of the present invention has also applied a patent “MUSICAL WATER TANK” (Ser. No. 12/326,896”) that has been approved on Mat 2009. By rotation of a motor outside a transparent container, a pump inside the transparent container is driven to rotate due to magnetic effect between magnetic parts and magnetic moving parts. The transparent container is filled with two liquids-colored water and transparent oil. Thus the colored water is forced by the pump to pass through a nozzle on the bottom and blow upward over the transparent oil so as to produce dynamic effects. The inventor further develops a water ball with dancing beads so as to improve the novelty and interests of water balls.

### SUMMARY OF THE INVENTION

Therefore it is a primary object of the present invention to provide a water ball with dancing beads in which the heads are blown upward repeatedly.

It is another object of the present invention to provide a water ball with dancing beads in which a first space and a second space are formed by a first plate, a second plate and a third plate for easy manufacturing, convenient assembly and mass production. The first space is formed between the first plate and the second plate while the second space is located between the second plate and the third plate.

In order to achieve above objects, a water ball with dancing beads of the present invention consists of a transparent container, a base and a driving member. The transparent container includes an opening arranged at a bottom side thereof and a bottom cover that seals the opening to form a closed container. The bottom side of the closed container is divided into a first space and a second space. The first space is mounted with an impeller therein and at least one vent arranged at a top surface thereof. The second space is disposed over the first space and having a hole set on a center of the bottom surface thereof the second plate so as to connect with the first space. The base is used for loading the closed container. The driving member is mounted in the base to drive the impeller in the closed container to rotate. A centrifugal force generated by the rotated impeller forces a plurality of beads in the first space passing the vent and flowing into the transparent container for showing dancing effects while the falling beads enter the second space through a gap on an inner circumference of the transparent container, pass the hole on the bottom surface and turn back to the first space. Thus the beads are blown out repeatedly.

### BRIEF DESCRIPTION OF THE DRAWINGS

FIG. 1 is a perspective view of an embodiment according to the present invention;

FIG. 2 is an explosive view of the embodiment in FIG. 1;

FIG. 3 is a front cross sectional view of the embodiment in FIG. 1.

### DETAILED DESCRIPTION OF THE PREFERRED EMBODIMENT

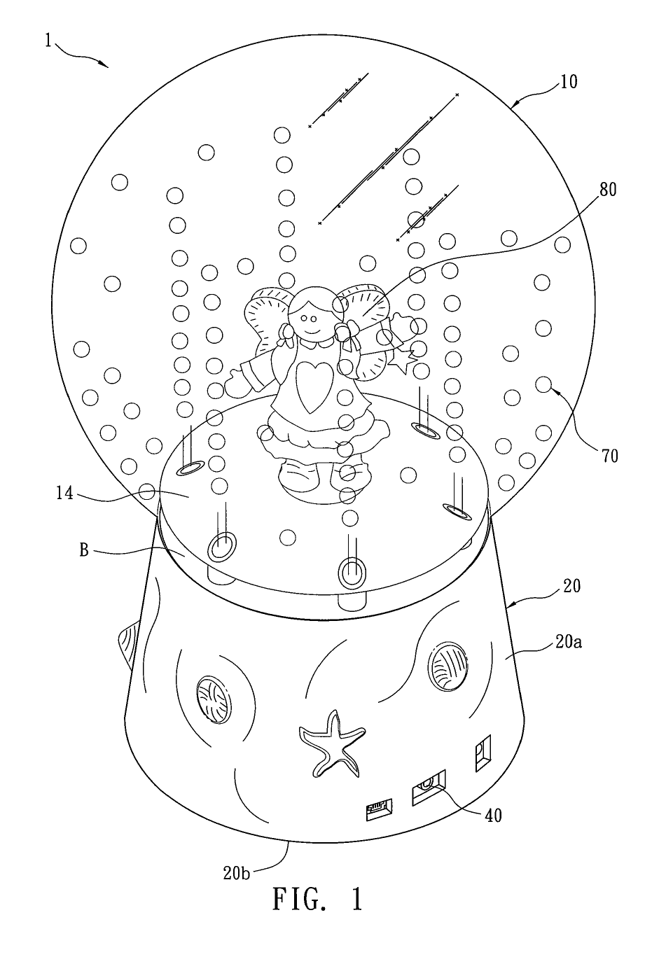

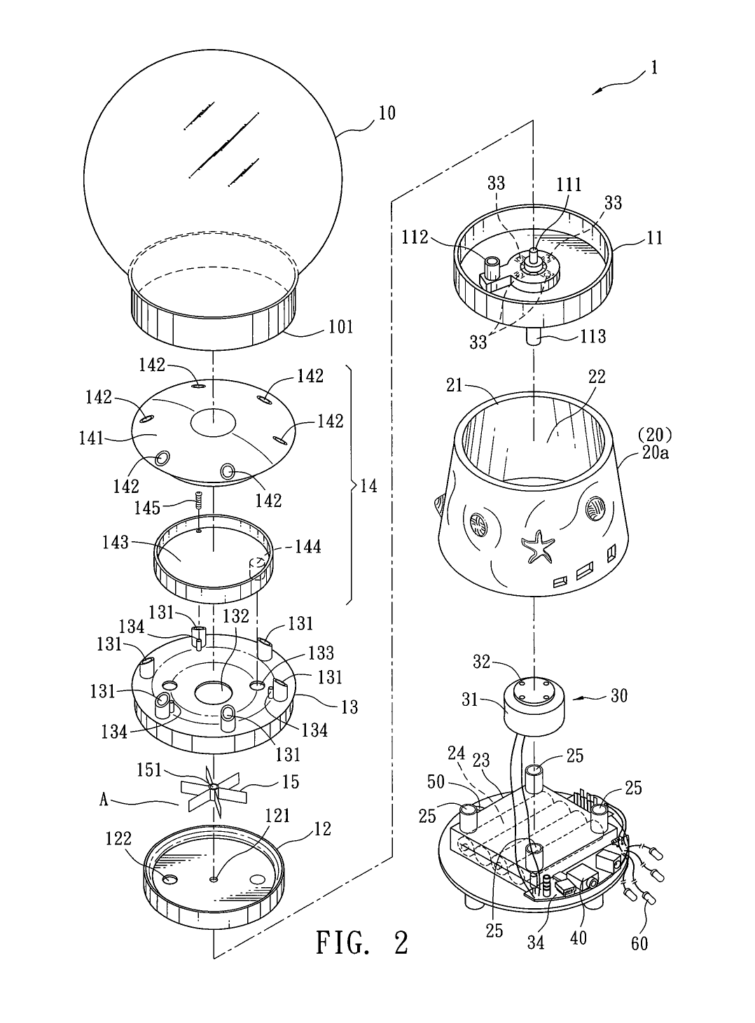

Refer to FIG. 1 and FIG. 2, a water ball with dancing beads of the present invention includes a transparent container 10, a base 20 and a driving member 30. There is no limit on the shape of the transparent container 10. As shown in FIG. 1 and FIG. 2, the transparent container 10 of this embodiment is a water ball. The transparent container 10 includes an opening 101 on a bottom side thereof and a bottom cover 11 that seals the opening 101 to form a closed container. A first space A is disposed on the bottom of the transparent container (closed container) 10 while a second space B is over the first space A. There are three plates—a first plate 12, a second plate 13 and a third plate 14 arranged with a certain interval from bottom to top. The first space A is formed between the first plate 12 and the second plate 13 while the second space B formed between the second plate 13 and the third plate 14.

A rotatable axis 111 is disposed on a center of the bottom cover 11 upward and at least one positioning pin 112 is arranged at a top surface of the bottom cover 11 while a plurality of rods 113 are set on a bottom surface of the bottom cover 11. A through hole 121 is mounted on a center of a bottom surface of the first plate 12 (also a center of a bottom surface of the first space A) and is inserted by the rotatable axis 111 and the circumference of the bottom surface of the first plate 12 is with a slanting surface for guiding beads moving upward more easily. Moreover, at least one positioning hole 122 corresponding to the positioning pin 112 on the top surface of the bottom cover 11 is mounted on the bottom surface of the first plate 12. An impeller 15 with a central hole 151 is mounted in the first space A by the central hole 151 assembling with the rotatable axis 111. At least one vent 131 is disposed projectingly on the second plate 13 that is a top surface of the first space A. In this embodiment, there are six vents 131. The circumference of the bottom surface of the second plate 13 is also formed a concave portion, with a slanting surface downward to the bottom surface. A hole 132 is set on a center of the bottom surface of the second plate 13—that's the bottom center of the second space B so as to connect with the first space A thereunder. A top surface 141 of the third plate 14 is a convex surface and is disposed with at least one through hole 142 corresponding to the vent 131. A bottom surface 143 of the third plate 14 is disposed with at least one positioning pin 144 corresponding to a positioning hole 133 arranged at the second plate 13 for convenience of assembly. The third plate 14 is further threaded with the second plate 13 by insertion of at least one screw 145 through a screw hole 134 on the second plate 13.

The base 20 consists of a surrounding wall 20a and a bottom plate 20b. The surrounding wall 20a includes an opening edge 21 on a top end thereof and a receiving space 22 on an inner side thereof for loading the closed container. A battery cell 23 for receiving at least one battery 24 is arranged at the bottom plate 20b. The bottom plate 20b is further disposed with a plurality of hole seats 25 that are assembled with the rods 113 on the bottom surface of the bottom cover 11 correspondingly for convenience of assembly.

The driving member 30 includes a motor 31 that is drive to rotate by a power source. The power source is mot limited to the battery 24 shown in FIG. 2, it can be an external power source. A shaft end of the motor 31 is disposed with a plurality of magnetic parts 32 and corresponding magnetic moving parts 33 are set on the rotatable axis 111 of the bottom cover 11. In this embodiment, there are four magnetic parts 32. When the motor 31 outside the closed container operates, the rotatable axis 111 and the impeller 15 in the closed container are also driven to rotate synchronously due to magnetic effect between the magnetic parts 32 and the magnetic moving parts 33. The magnetic force can penetrate through various materials such as air. Therefore, there is no need to arrange a waterproof packing around the driving member 30 for preventing liquid leakage or infiltration. The driving member 30 further includes a circuit board 34 that is connected with the battery 24 (power source).

The water ball 1 is further composed of a switch 40 that is connected with the circuit board 34 so as to control on/off of the water ball 1. The water ball 1 further includes a speaker 50 and/or LED lighting member 60 that connect with the circuit board 34 for generating visual and sound effects. Moreover, the transparent container 10 is mounted with various ornaments 80 that are designed to be used together with dancing beads for better display effect.

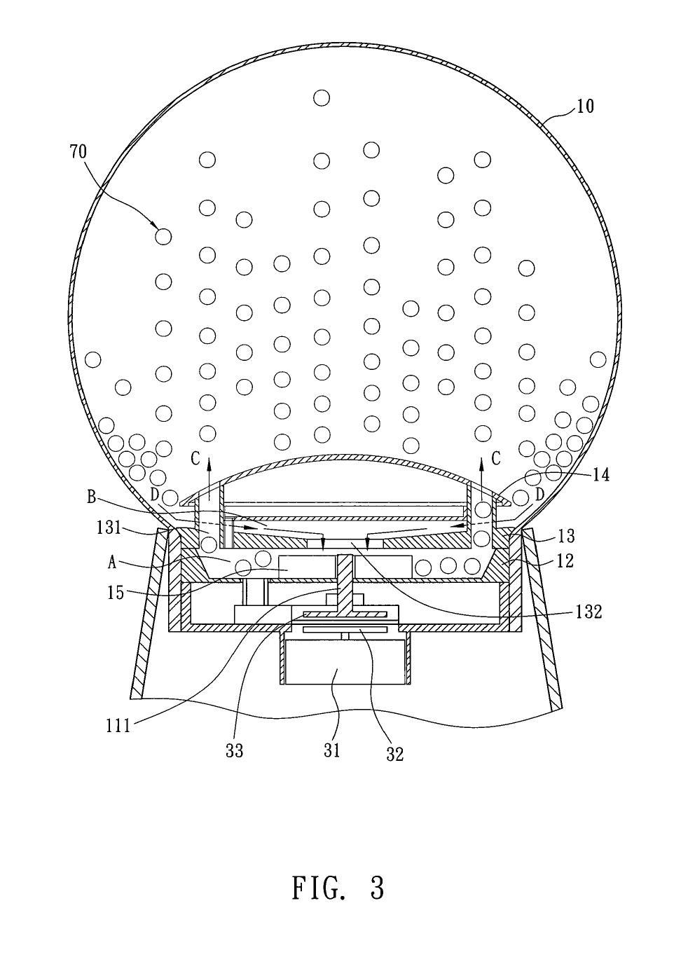

Refer to FIG. 3, when the motor 31 rotates, the rotatable axis 111 and the impeller 15 in the closed container are also driven to rotate synchronously due to magnetic effect between the magnetic parts 32 and the magnetic moving parts 33. The centrifugal force generated by the rotated impeller 15 forces a plurality of beads 70 in the first space A passing through the vent 131 and moving upward into the transparent container 10, as indicated by an arrow C in FIG. 3. Thus a plurality of dancing beads 70 is displayed, as shown in FIG. 1 and FIG. 3. As to the beads falling freely, they move along the convex top surface 141, flow through a gap on an inner circumference of the transparent container 10, and enter the second space B, as indicated by an arrow D. Then they move along the slope of the second plate 13 and turn back to the first space A through the hole 132. By repeated cycles of above processes, a plurality beads is blown upward continuously.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents

What is claimed is:

1. A water ball with dancing beads comprising:
a transparent container having an opening arranged at a bottom side thereof, a bottom cover that seals the opening to form a closed container that is filled with liquid, a first space with an impeller disposed on a bottom of the closed container and having at least one vent on a top surface thereof, and a second space arranged over the first space and having a hole on a center of a bottom surface thereof for connection with the first space;
a base for loading the closed container, and
a driving member mounted in the base for driving the impeller to rotate;
wherein when the impeller rotates, a centrifugal force generated forces a plurality of beads in the first space passing through the vent and blowing upward into the transparent container while beads falling freely slide into the second space through a gap on an inner circumference of the transparent container, pass the hole and turn back to the first space; thus the beads are blown up continuously.

2. The device as claimed in claim 1, wherein the transparent container is a ball.

3. The device as claimed in claim 1, wherein a rotatable axis for being assembled with the impeller is disposed on a center of the bottom cover upward.

4. The device as claimed in claim 3, wherein the first space and the second space are formed by a first plate, a second plate and a third plate arranged with a certain interval from bottom to top; a through hole to be inserted by the rotatable axis is mounted on a center of a bottom surface of the first plate; the second plate is a concave portion disposed with at least one vent on a center of a bottom surface thereof while a through hole corresponding to the vent is arranged at a top surface of the third plate.

5. The device as claimed in claim 4, wherein circumference of a bottom surface of the first plate is with a slanting surface for guiding beads moving upward more easily.

6. The device as claimed in claim 4, wherein the third plate is a convex surface so that beads flow down freely from the convex surface.

7. The device as claimed in claim 1, wherein a battery cell for loading at least one cell is disposed in the base.

8. The device as claimed in claim 1, wherein the driving member includes a motor that is drive to rotate by a power source and a shaft end of the motor is arranged with a plurality of magnetic parts and corresponding magnetic moving parts are set on a rotatable axis of the bottom cover so that the rotatable axis and the impeller in the closed container are driven to rotate synchronously due to magnetic effect between the magnetic parts and the magnetic moving parts when the motor outside the closed container rotates.

9. The device as claimed in claim 3, wherein the driving member includes a motor that is drive to rotate by a power source and a shaft end of the motor is arranged with a plurality of magnetic parts and corresponding magnetic moving parts are set on the rotatable axis of the bottom cover so that the rotatable axis and the impeller in the closed container are driven to rotate synchronously due to magnetic effect between the magnetic parts and the magnetic moving parts when the motor outside the closed container rotates.
